(19) United States
(12) Patent Application Publication
(10) Pub. No.: US 2008/0291276 A1
(43) Pub. Date: Nov. 27, 2008

(54) Method for Driver Assistance and Driver Assistance Device on the Basis of Lane Information

(76) Inventor: Martin Randler, Immcustaad (DE)

Correspondence Address: KENYON & KENYON LLP, ONE BROADWAY, NEW YORK, NY, 10004, US

(21) Appl. No.: 10/574,647

(22) PCT Filed: Sep. 10, 2004
(86) PCT No.: PCT/EP2004/052124

§ 371 Date: Aug. 4, 2008

(30) Foreign Application Priority Data
Oct. 24, 2003 (DE) 103 49 631.9

(51) Int. Cl. H04N 7/18; B62D 1/28

(52) U.S. Cl. 348/149; 701/1; 348/E07.085

(57) ABSTRACT

A method for driver assistance and a driver assistance device which operates on the basis of lane information are described. The lane information is ascertained from an image recorded by an image sensor and/or estimated on the basis of objects in this image depending on the weather conditions.

### FIELD OF THE INVENTION

The present invention relates to a method for driver assistance and a driver assistance device which operates on the basis of lane information.

### BACKGROUND INFORMATION

Driver assistance systems which operate on the basis of lane information are known in the art. An example of such a driver assistance system is a warning system which warns the driver upon departing from the lane and/or upon imminent departure from the lane. For example, published European patent document EP 1074430 discloses a system of this type, in which the road surface (lane) on which the vehicle moves is established using image sensor systems, and the driver is warned when the vehicle departs from this lane and/or threatens to depart from this lane. Furthermore, additional driver assistance systems of this type are disclosed in published German patent document 103 11 518.8, having the priority date of Apr. 30, 2002, and published German patent document 102 38 215.8, having the priority date of Jun. 11, 2002. In these systems, image sensor systems which are installed in the vehicle and which record the scene in front of the vehicle are used to detect the lane. The boundaries of the lane, and therefore the lane itself, are ascertained from the recorded images of the lane boundary markings. Ascertaining the lane is accordingly essentially a function of the existing visibility, the known systems having to be shut down early in the event of poor visibility.

An example of the recognition and modeling of lane boundary markings from video images, lane width, lane curvature, curvature change, and lateral offset of the vehicle, among other things, being ascertained as the model parameters, is described in German patent document DE 19627 938.

### SUMMARY

By using further information in addition or alternatively to the lane boundary markings, from which the variables describing the course of the road (lane) are derived, the availability of a driver assistance system based on lane information is significantly increased in accordance with the present invention. It is particularly advantageous that the driver assistance system is also available if the lane boundary markings are no longer reliably recognizable. This is significant above all in poor weather conditions, for example, a wet road surface, a snow-covered road surface, etc., or in the event of poorly visible and/or nonexistent lane boundary markings.

It is particularly advantageous that in addition to the lane boundary markings or even instead of these, other information may be used individually or in any arbitrary combination in each case for lane identification, such as the trajectory of one or more preceding vehicles, the tracks of one or more preceding vehicles in the event of rain or snow, for example, the trajectory of one or more oncoming vehicles, and the course of road boundaries such as guard rails, curbs, etc. Lane information may also be derived (estimated) from this data, which forms the lane information (lane data) for the driver assistance system instead of or together with the lane information ascertained from the lane boundary markings. Lane identification thus becomes more reliable, in particular if the actual lane boundary markings are no longer sufficiently recognizable.

It is particularly advantageous that this is performed solely on the basis of the signals of the image sensor system, without additional hardware.

It is particularly advantageous that quality indices for the lane data detection are determined from the image contrast, for example, using which the particular lane data which has been ascertained may be weighted and taken into consideration during the merger of the lane data provided to the driver assistance system from the individual lane data. It is particularly advantageous in this context that forming an overall quality index for the lane data detection from the individual quality indices is provided, the driver assistance system being shut down if this overall quality index falls below a specific value. It is also advantageous if the quality index is derived from a comparison of the estimate with the measurement, the deviation of the measured points from the estimated line (variance) being used, for example.

Furthermore, it is advantageous that by increasing the availability of the driver assistance system even in poor weather conditions, the driver assistance system functions precisely when the driver particularly needs the assistance. The driver is significantly relieved by the operation of the driver assistance system during poor weather conditions in particular.

When ascertaining the lane data from information other than the lane boundary markings (which is also referred to in the following as lane data estimate), data of a global positioning system and/or data of the navigation map and/or immobile objects standing next to the road, which are classified by the video sensor, are particularly advantageously analyzed for the plausibility check of the lane data. Lane data acquisition (lane data estimate) thus becomes more reliable.

It is also particularly advantageous that in the event of loss of data values, for example, the values for the lane width, values before the loss or empirical values and/or average values are used for these variables in the lane data estimate. Therefore, the function of the lane data estimate is also ensured under these circumstances.

### BRIEF DESCRIPTION OF THE DRAWINGS

FIG. 1 shows a block diagram of a driver assistance system for driver warning and/or for response if the vehicle threatens to depart from the lane.

FIG. 2 shows a schematic chart illustrating a first exemplary embodiment for providing the lane data information.

FIGS. 3 through 5 show various flow charts illustrating operation of a second example embodiment for the measurement and estimate of lane data and its analysis in the driver assistance system.

### DETAILED DESCRIPTION

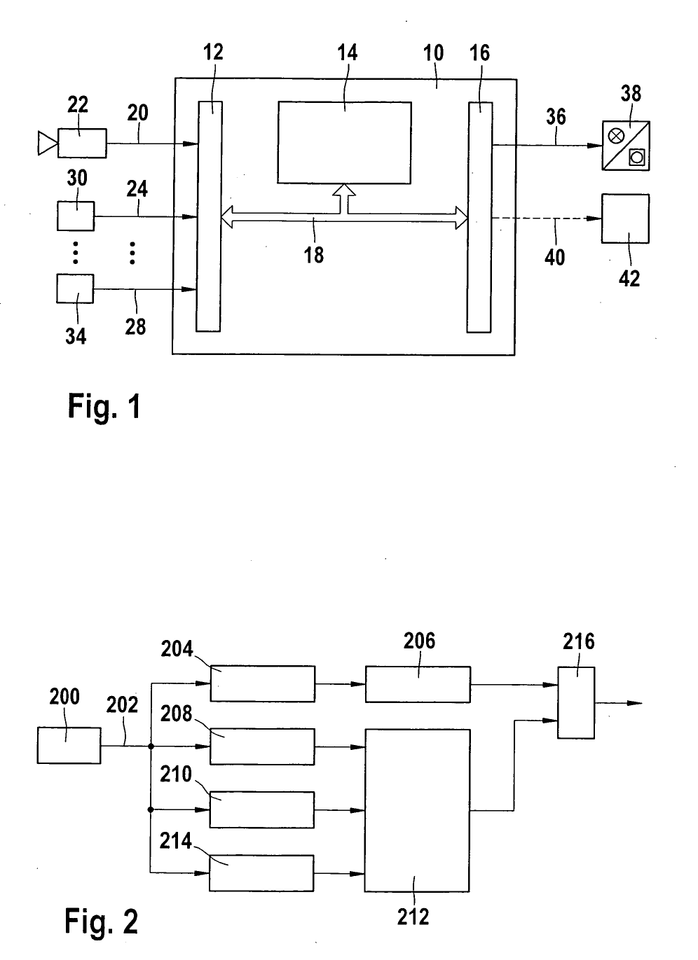

FIG. 1 shows a device which is used for warning the driver and/or for response if the vehicle departs from the lane. A control unit and/or analyzer unit 10, which has an input circuit 12, a microcomputer 14, and an output circuit 16, is shown. These elements are connected to one another using a bus system for mutual data exchange. Input lines from different measuring devices are connected to input circuit 12, via which the measured signals and/or measured information are transmitted. A first input line 20 connects input circuit 12 to an image sensor system 22, which is situated in the vehicle and which records the scene in front of the vehicle. Corresponding image data is transmitted via input line 20. Furthermore, input lines 24 through 26 are provided, which connect input circuit 12 to measuring devices 30 through 34. These measuring devices are, for example, measuring devices for measuring the vehicle velocity, for detecting the steering angle, and for detecting further operating variables of the vehicle which are significant in connection with the function of the driver assistance system. Furthermore, map data and/or position data of the vehicle is supplied via these input lines. At least one warning device 38 is activated via output circuit 16 and output line 36, such as a warning light and/or a loudspeaker for an acoustic warning and/or for a voice output and/or a display for displaying an image, with the aid of which the driver is informed and/or warned of the imminent lane departure. A haptic warning (e.g., steering wheel vibration) may also be provided. In another exemplary embodiment, a servo system 42 is alternatively or additionally activated via output circuit 16 and an output line 40, which automatically guides the vehicle back into the lane by intervening in the steering of the vehicle and thus preventing it from departing the lane.

In ascertaining the lane data conventionally, lane modeling parameters are ascertained by analyzing the detected image according to an imaging specification which includes the camera data and being adapted to the measured image. Thus, the driver assistance system analyzes the image detected by the image sensor and ascertains objects in the image, in particular the lane boundary markings (e.g., center lines, etc.). The courses of the ascertained lane boundary markings (left and right) are then mathematically approximated by functions, e.g., as the clothoid model, approximated by a second-order polynomial, for example. Parameters of these equations are, for example, curvature and curvature change, and the distance of the host vehicle to the boundary markings on the right and on the left. Furthermore, the angles between the tangents of the calculated lane and the direction of movement of the host vehicle may be ascertained. The lane information ascertained in this way is then supplied to the driver assistance system, which recognizes an imminent lane departure and warns the driver and/or initiates countermeasures at the suitable instant on the basis of the actual trajectory (trajectories) of the vehicle (determined on the basis of the steering angle, for example).

As long as the lane boundary markings are clearly recognizable in the recorded image, the calculation of the lane data as described above is precise and reliable. In the event of poor weather conditions and/or poor visibility and/or poorly visible or nonexistent lane boundary markings, the method described above may be imprecise and/or may not be able to provide a result. Systems operating on the basis of the lane data would then have to be shut down in such situations. Therefore, in accordance with the present invention, an extension of the lane data detection and thus an extension of the driver assistance system connected thereto is described in the following, which allows further operation of the driver assistance system even in the event of poor weather conditions and/or poorly visible or nonexistent lane boundary markings by calculating a lane (estimating a lane) on the basis of information from the recorded image other than the lane boundary markings, while incurring no additional outlay in hardware equipment costs.

A schematic chart is illustrated in FIG. 2, which represents a first exemplary embodiment in regard to the above-mentioned extension of the lane data detection. The schematic chart represents the program running on the microcomputer in control and/or analyzer unit 10 in this case.

The starting point is an image sensor 200 which is installed in or on the vehicle and records the scene in front of the vehicle. Appropriate image signals are relayed via lines 202 to analyzer unit 10. In addition to the lane data calculation on the basis of lane boundary markings described above, analyzer unit 10 analyzes the transmitted images as follows.

First, as described above, the lane boundary markings in the image are recognized in module 204 and then the lane data is calculated in module 206. In the illustrated exemplary embodiment, the courses of the tracks of one or more preceding vehicles, which are visible on a wet road surface, in snow, etc., for example, are ascertained in a second module 208. This is achieved through analysis and object recognition in the image on the basis of the gray-scale values, for example (e.g., gradient analysis). Within this representation, objects are also understood as the lane boundary marking and/or the road boundary construction (guard rails, etc.). The track recognized in this way is then described mathematically using the cited parameters as described above. The lane width (estimated, from map data, etc.) is also considered in this case.

The trajectory of one or more preceding vehicles and/or oncoming vehicles is recorded in module 210 on the basis of sequential images. This is performed through object recognition and object tracking in the individual images, the parameters being derived from the changes in the object. The lane width and/or the offset between oncoming traffic and traffic on the current lane are considered as estimated values. Stationary objects on the road boundary, such as guard rails, are analyzed and the trajectory is determined on the basis of this information in module 210 as an alternative or as a supplement.

Furthermore, a quality index (e.g., a number between 0 and 1) for the particular lane data is ascertained on the basis of the images provided by the image sensor on the basis of the image contrasts in the area of the particular analyzed object, for example, and is also provided with all ascertained lane data. An alternative or supplementary measure for ascertaining the quality index is a comparison of the estimate with the measurement, the deviation of the measured points from the estimated line (variance) being used in particular. If the variance is large, a small quality index is assumed; if the variance is small, a high quality index is specified.

The additional lane data ascertained in this way is analyzed to form a set of estimated lane data, possibly considering the quality indices, in lane data estimate module 212. In an example embodiment, this is performed by weighting the lane data ascertained in different ways using the assigned ascertained quality index and calculating the resulting lane data from this weighted lane data of the different sources, e.g., by calculating the mean value. A resulting quality index is thus determined.

In an example embodiment, a global positioning system and/or map data 214 is also provided, whose information is evaluated within the lane data estimate as a plausibility check. For example, it is checked on the basis of this map data and/or positioning data whether or not the ascertained lane data corresponds to the map data within the required precision. In the latter case, a quality index for the lane data is determined as a function of a comparison of the estimated data with the map data, the quality index being smaller at larger deviations than at smaller deviations. If specific lane data cannot be ascertained from the available data, experiential values or values before the loss of the information are used. For example, if the width of the lane cannot be ascertained from the currently available information, either experiential values for the lane width or the values established for the lane width during the last lane data estimate are used.

The lane data estimated in this way is then supplied to a lane data merger 216, in which the estimated lane data having the resulting quality index and the calculated lane data (also having a quality index) on the basis of the lane boundary markings are combined into the lane data used for the function. The data merger is also performed here while taking the quality indices into consideration, for example, by discarding the corresponding data in the event of a very low quality index, or in the event of a very high quality index of one of the calculation pathways, using only this data and calculating a mean value in the intermediate area. A resulting quality index may also be ascertained accordingly.

The lane data ascertained in this way is provided to the analyzer unit, which then warns the driver upon imminent lane departure on the basis of this lane data, for example.

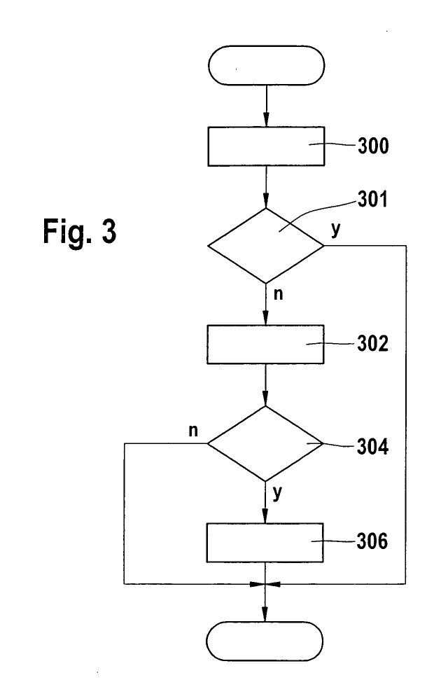

A further exemplary embodiment of the driver assistance system and method is illustrated in connection with flow charts in FIGS. 3 through 5. The flow charts represent programs or parts of programs for the microcomputer which is situated in analyzer unit 10.

FIG. 3 shows an example which represents an analysis of the ascertained lane data using the example of a system for warning before departing the lane. First, in step 300, the lane data which is measured and/or estimated or derived from a merger of the two, and/or the shutdown information (see below) is input. In step 301, it is checked whether there is shutdown information. If so, the program is ended and executed again at the next instant. Otherwise, in step 302, the actual trajectories of the vehicle and, therefrom, the future course of the vehicle (left and/or right vehicle side) are calculated as a mathematical function (with the assumption that the vehicle will maintain the current course, possibly taking typical driver reactions into consideration) on the basis of vehicle variables such as steering angle, yaw rate, lateral acceleration, vehicle geometry data, etc. Then, in step 304, imminent lane departure is derived (intersections of the mathematical functions in the future) by comparing the ascertained lane data and the future course of the vehicle (on one or both lane sides). If this is the case, according to step 306, the driver is acoustically and/or optically and/or haptically warned, and, in one exemplary embodiment, the vehicle is possibly kept in the lane through steering intervention. If the comparison shows that lane departure is not to be feared, the warning and/or the action described does not occur.

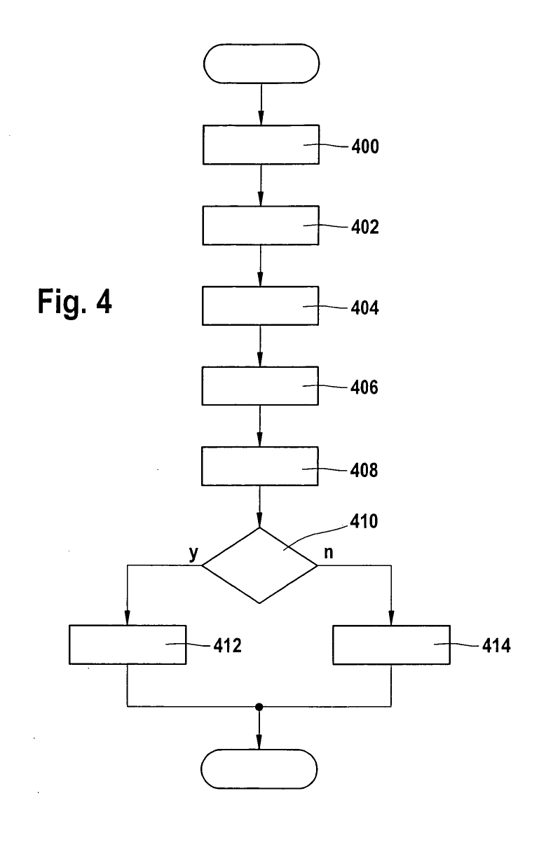

FIG. 4 illustrates a method for ascertaining lane data on the basis of available estimated lane data. First, in step 400, the lane boundary markings are recognized from the image detected by video sensor 200 using methods of image analysis, e.g., on the basis of the image contrasts and comparison with stored models. Furthermore, in step 402, a quality index is calculated from the contrast of the image, in particular from the contrast in the area of the lane boundary markings, and/or the variance of the measured values and the estimated values. In an exemplary embodiment, this quality index is a value between 0 and 1, the quality index being higher the higher the contrast of the image and/or the smaller the variance. In following step 404, the lane data is then calculated on the basis of the recognized lane data markings, in particular, a second-order polynomial is produced and the lane parameters of curvature and curvature change and distance on the left and right to the host vehicle are calculated, so that lane data for the left and right boundaries is provided. In step 406, the lane data from the lane data estimate (which is also provided for right and left) and the quality index connected thereto are input. In step 408, the merger of this lane data is then performed for each side individually to produce the resulting lane data. This is performed while taking the established quality indices into consideration. Thus, for example, with a high quality index (for example, >0.75) in the detection of the lane boundary markings, the lane data estimate is not used at all. There may also be provided other exemplary embodiments in which, vice versa, with a high quality index of the lane data estimate and a low quality index of the lane boundary markings recognition (<0.3, for example), the lane data from the estimate is used. In other cases, the merger is performed by calculating a weighted mean value from the lane data available, for example, the weighting being performed on the basis of the quality indices. A final resulting quality index is ascertained from the quality indices, as with the lane data. In step 410, it is checked whether this resulting quality index has reached a specific value, such as 0.5. If not, instead of the lane data, shutdown information is sent to the following systems in step 412, in such a way that reliable lane data cannot be ascertained. Otherwise, the resulting lane data is relayed to the subsequent application (step 414).

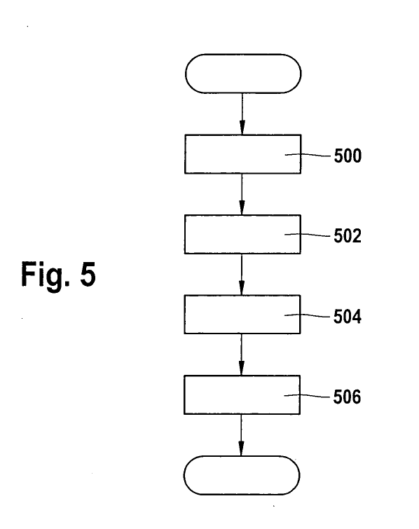

FIG. 5 shows a flow chart which outlines an exemplary method for ascertaining the estimated lane data. The image ascertained by the video sensor is also analyzed in first step 500 here. Different objects in the image are recognized, such as preceding vehicles, oncoming vehicles, or stationary objects such as guard rails which identify the road boundary, and stationary objects outside the road, such as trees, etc. The analysis of the image and the object recognition and classification of the objects are performed in accordance with an appropriate image analysis method, e.g., on the basis of the contrasts existing in the image and contour comparisons. In following step 502, quality indices for the object recognition are ascertained from the contrasts of the image details in which the ascertained objects lie, and/or from the variance of the corresponding measured and estimated values. Every recognized object is provided with a corresponding quality index (e.g., a value between 0 and 1) in this case.

In subsequent step 504, lane data is derived from the objects. For preceding vehicles or oncoming vehicles, this is performed by analyzing sequential images, from which the movement of the vehicles, their direction, and their trajectories in the past may be ascertained. The trajectories ascertained in this way are then used for determining a lane course. The oncoming traffic is suitable for this purpose in particular, whose trajectory in the past represents the lane to be traveled by the vehicle. Taking the lateral distance between the preceding vehicles and oncoming vehicles into consideration, the course of the current lane is ascertained. The above-mentioned lane data is then established in turn from the trajectory and an assumed or ascertained lane width.

In rain or poor visibility or even in snow, the track of the preceding vehicle which is then visible may be analyzed from the recorded image. Trajectories may be calculated from the image analysis which approximately correspond to the course of the lane boundary markings when an assumed lane width is taken into consideration. The lane data is also represented here as a mathematical function from the objects recognized in the image.

As a further possibility, stationary objects may be analyzed to estimate lane data, in particular guard rails or other delimitations which delimit the road on at least one side. The course of these delimitations may be analyzed in the image and a trajectory may be calculated therefrom. Taking typical lateral distances and lane widths into consideration, lane data (right and left) may then be ascertained.

As noted above, a quality index is assigned to every ascertained object, which is correspondingly included with the road data ascertained on the basis of this object. Furthermore, stationary objects, which are classified by the video sensor and mark areas which may not be traveled, are used for the plausibility check of the estimated lane. If it is recognized that the estimated lane is located in the area of such stationary objects, an erroneous lane estimate is to be assumed.

The ascertained lane data and the resulting quality index are then forwarded for further analysis (see FIG. 4).

In an example embodiment, the lane estimate is only performed when poor weather conditions have been recognized, while in good weather conditions and good visibility, the estimate is dispensed with. Poor weather conditions are recognized in this case if the windshield wipers are active beyond a specific rate and/or if a rain sensor recognizes rain and/or if the video sensor ascertains a low visibility range.

Furthermore, in one exemplary embodiment, the quality of the lane estimate is reduced if it is recognized that the preceding vehicle is turning off or changing lanes.

1-11. (canceled)

12. A method for providing driving assistance to a driver of a vehicle, comprising:
obtaining a composite lane information regarding a road lane in which the vehicle is traveling, wherein the composite lane information is derived from at least two characterizing information items regarding the lane; and
triggering at least one of an output of driver-assistance information and a vehicle-control action based on the composite lane information.

13. The method as recited in claim 12, wherein the composite lane information is derived at least partially based on lane boundary markings detected from an image of the road lane obtained using a camera.

14. The method as recited in claim 13, wherein the composite lane information is derived at least partially based on objects detected from the image of the road lane.

15. The method as recited in claim 14, wherein the composite lane information is derived at least partially based on at least one of an oncoming vehicle, a preceding vehicle, and a stationary object that marks a boundary of the road lane.

16. The method as recited in claim 14, wherein the composite lane information is derived at least partially based on tracks of a preceding vehicle.

17. The method as recited in claim 14, wherein each information used to derive the composite lane information is assigned a quality index value.

18. The method as recited in claim 17, wherein the assigned quality index value for each information used to derive the composite lane information is considered for deriving the composite lane information.

19. The method as recited in claim 18, wherein the quality index value is derived from at least one a contrast of the image and a deviation between stored estimated lane boundary data and measured lane boundary data.

20. The method as recited in claim 18, wherein the composite lane information and the assigned quality index values are transmitted to an analyzer unit for analysis.

21. A driver assistance system for a driver of a vehicle, comprising:
an image sensor unit for obtaining an image of a road lane in which the vehicle is traveling:
an analyzer unit for obtaining a composite lane information regarding the road lane in which the vehicle is traveling, wherein the composite lane information is derived from at least two characterizing information items regarding the road lane; and
a control unit for triggering at least one of an output of driver-assistance information and a vehicle-control action based on the composite lane information.

22. The driver assistance system as recited in claim 21, wherein the analyzer unit ascertains a quality index value for each characterizing information regarding the road lane used to derive the composite lane information.
